(19) United States
(12) Patent Application Publication
(10) Pub. No.: US 2025/0386363 A1
(43) Pub. Date: Dec. 18, 2025

(54) DETERMINING NON-PRIMARY CHANNEL THAT IS AVAILABLE FOR NON-PRIMARY CHANNEL ACCESS (NPCA)

(71) Applicant: NEWRACOM, Inc., Irvine, CA (US)

(72) Inventors: Si-Chan NOH, Seoul (KR); Joonsoo LEE, Seoul (KR)

(73) Assignee: NEWRACOM, Inc., Irvine, CA (US)

(21) Appl. No.: 19/228,165

(22) Filed: Jun. 4, 2025

Related U.S. Application Data
(60) Provisional application No. 63/659,283, filed on Jun. 12, 2024.

(51) Int. Cl. H04W 74/00; H04W 72/0457; H04W 74/0816

(52) U.S. Cl. CPC H04W 74/002; H04W 72/0457; H04W 74/0816

(57) ABSTRACT

Disclosed herein is a method performed by a wireless device to perform non-primary channel access (NPCA). The method includes overhearing a control frame and a corresponding response frame transmitted in a primary channel in an overlapping basic service set (OBSS), extracting bandwidth information from a field of the control frame, determining an available non-primary channel based on a bandwidth indicated by the bandwidth information, and performing NPCA in the determined available non-primary channel in the BSS after overhearing the response frame.

### CROSS-REFERENCE TO RELATED APPLICATION

This application claims the benefit of U.S. Provisional Application No. 63/659,283, filed Jun. 12, 2024, titled “Conditions for switching Non-Primary Channel Access (NPCA)”, which is hereby incorporated by reference.

### TECHNICAL FIELD

The present disclosure generally relates to wireless communications, and more specifically, relates to determining a non-primary channel that is available for non-primary channel access (NPCA).

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHZ, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming.

According to traditional IEEE 802.11 wireless networking standards, before a wireless device can transmit a physical layer protocol data unit (PPDU), the wireless device has to verify that the transmission bandwidth, including the primary channel, is idle. For example, consider a station (STA) having an operating bandwidth (OPBW) of 80 MHz. The 80 MHz operating bandwidth may include a primary 20 MHZ (P20) channel, a secondary 20 MHz (S20) channel, and a secondary 40 MHz (S40) channel. To transmit a 40 MHz PPDU, both the P20 and S20 channels within the 80 MHz operating bandwidth have to be idle. In a scenario where the P20 channel is busy but the S40 is idle, the STA is not allowed to transmit a 40 MHz PPDU in the S40 channel (even though it is idle) due to an existing rule that transmission is not allowed when the primary channel is busy.

In IEEE 802.11bn (also referred to as ultra high reliability (or “UHR”)), with the increase in the operating bandwidth (e.g., to 320 MHZ), the traditional rule that prevents PPDU transmission when the primary channel is busy and the secondary channel is idle (e.g., P20 channel is busy and secondary 160 MHz (S160) channel is idle) is seen as inefficient and wasteful of resources. The concept of non-primary channel access (NPCA) has been proposed to address this issue. With NPCA, transmission and reception can be performed in an idle non-primary channel (e.g., a secondary channel) even if the primary channel is busy. That is, even if the primary channel is busy, if there is a non-primary channel that is idle, NPCA allows transmission/reception in the idle non-primary channel. NPCA should be performed in the non-primary channel in a manner that does not interfere with the transmission/reception that occurs in the primary channel in the overlapping basic service set (OBSS).

To achieve successful NPCA, the wireless devices that wish to participate in NPCA should have an accurate and consistent view of the non-primary channel that is available for NPCA. If the wireless devices that wish to participate in NPCA have inaccurate or differing views of the available non-primary channel, NPCA may be unsuccessful and/or cause interference in the OBSS, which can reduce the overall efficiency of the wireless network.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing the overcall concept of non-primary channel access (NPCA), according to some embodiments.

FIG. 11 is a diagram showing a wireless network topology in which NPCA may be performed, according to some embodiments.

FIG. 12 is a diagram showing an example of a multi-user request-to-send (MU-RTS) frame and clear-to-send (CTS) frame exchange in BSS1, according to some embodiments.

FIG. 13 is a diagram showing the available non-primary channel from the perspective of AP2, according to some embodiments.

FIG. 14 is a diagram showing the available non-primary channel from the perspective of STA2-1, according to some embodiments.

FIG. 15 is a diagram showing how AP2's transmission in a non-primary channel that is perceived by AP2 as being available for NPCA can cause interference in BSS1, according to some embodiments.

FIG. 16 is a flow diagram of a method for performing NPCA, according to some embodiments.

FIG. 17 is a flow diagram of another method for performing NPCA, according to some embodiments.

### DETAILED DESCRIPTION

The present disclosure generally relates to wireless communications, and more specifically, relates to determining a non-primary channel that is available for non-primary channel access (NPCA).

As mentioned above, to achieve successful NPCA, the wireless devices that wish to participate in NPCA should have an accurate and consistent view of the non-primary channel that is available for NPCA. If the wireless devices that wish to participate in NPCA have inaccurate or differing views of the available non-primary channel, NPCA may be unsuccessful and/or cause interference in the overlapping basic service set (OBSS), reducing the overall efficiency of the wireless network.

The present disclosure describes a technique that allows wireless devices that wish to participate in NPCA to accurately determine a non-primary channel that is available for NPCA in a consistent manner (such that the wireless devices have the same view of the non-primary channel that is available for NPCA). According to some embodiments, a wireless device belonging to a basic service set (BSS) may overhear a control frame and a corresponding response frame transmitted in a primary channel in an overlapping basic service set (OBSS). The control frame and the corresponding response frame may be frames that are exchanged in the OBSS for establishing a transmission opportunity (TXOP) in the OBSS. For example, the control frame and the corresponding response frame may be a multi-user request-to-send (MU-RTS) frame and a clear-to-send (CTS) frame, respectively. The wireless device may extract bandwidth information from a field of the control frame and determine an available non-primary channel based on a bandwidth indicated by the extracted bandwidth information. The wireless device may then perform NPCA in the determined available non-primary channel in the BSS after overhearing the response frame. In an embodiment where the control frame is a MU-RTS frame, the field from which the bandwidth information is extracted may be an uplink bandwidth (UL BW) field that is used for indicating a bandwidth of the control frame. The wireless device may perform NPCA in the BSS during a transmission opportunity (TXOP) established in the OBSS and end NPCA in the BSS when the TXOP established in the OBSS ends.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

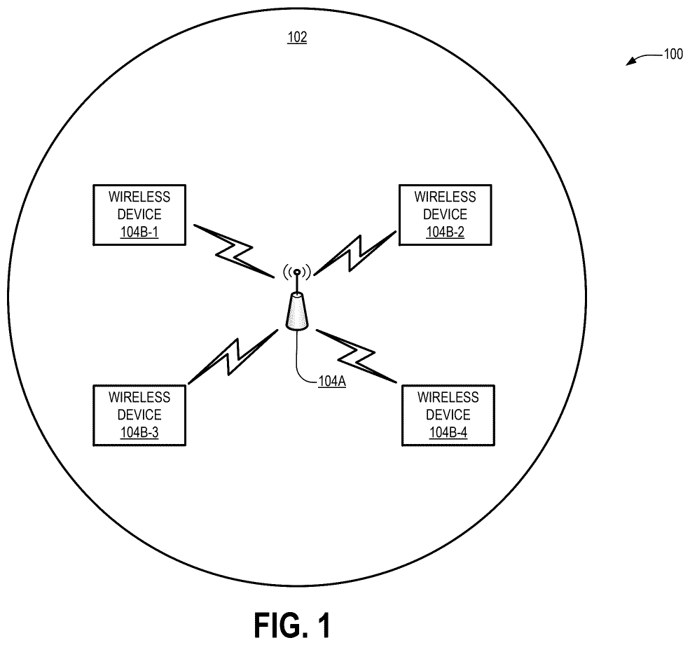

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B1-104B4 that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B1-104B4) may be collectively referred to as STAs. However, for case of description, only the non-AP STAs may be referred to as STAs unless the context indicates otherwise. Although shown with four non-AP STAs (e.g., the wireless devices 104B1-104B4), the WLAN 100 may include any number of non-AP STAs (e.g., one or more wireless devices 104B).

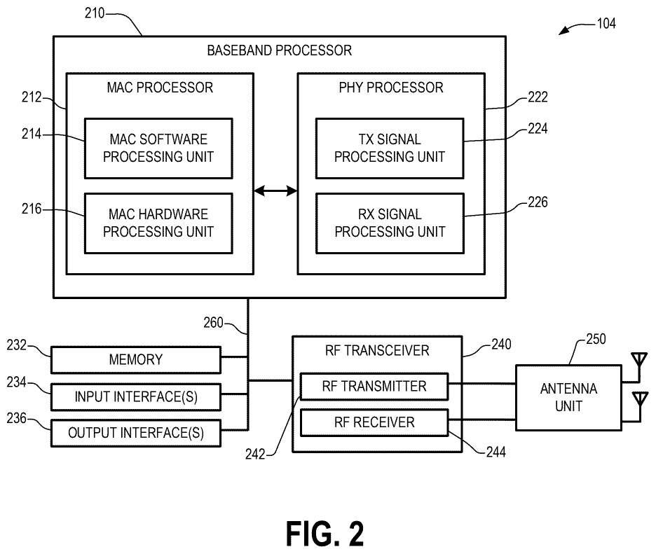

FIG. 2 illustrates a schematic block diagram of a wireless device 104, according to an embodiment. The wireless device 104 may be the wireless device 104A (i.e., the AP of the WLAN 100) or any of the wireless devices 104B1-104B4 in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

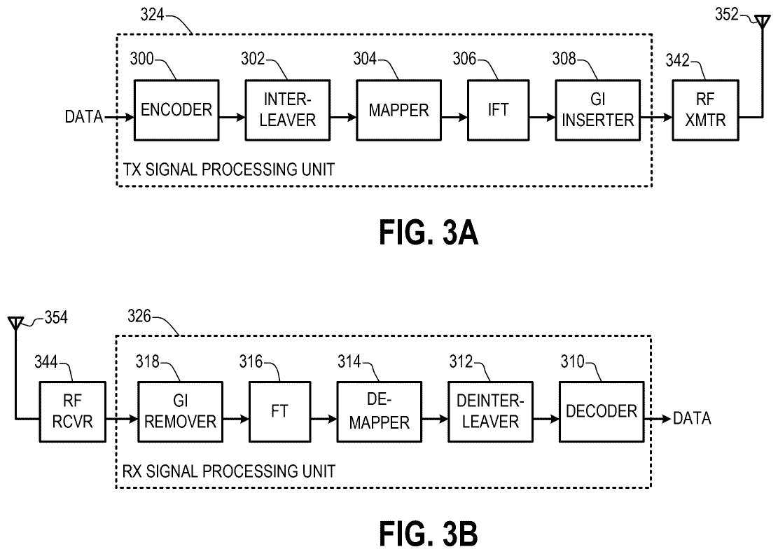

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHZ, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

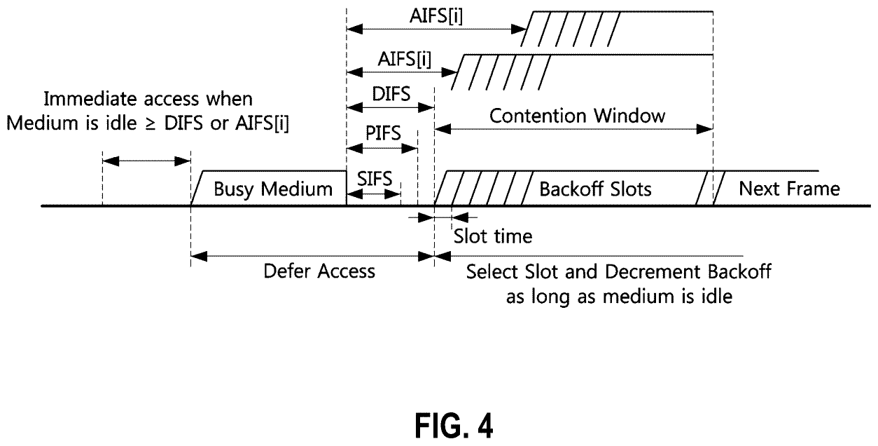

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS[AC]) has elapsed. When transmitted by the QOS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

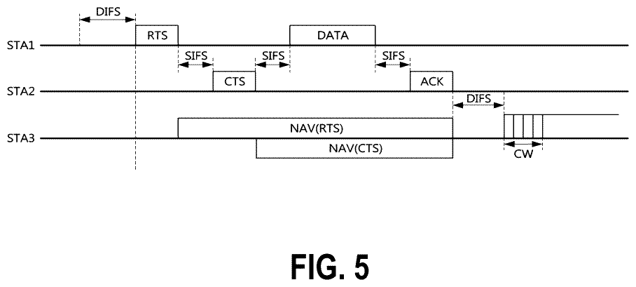

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 docs not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

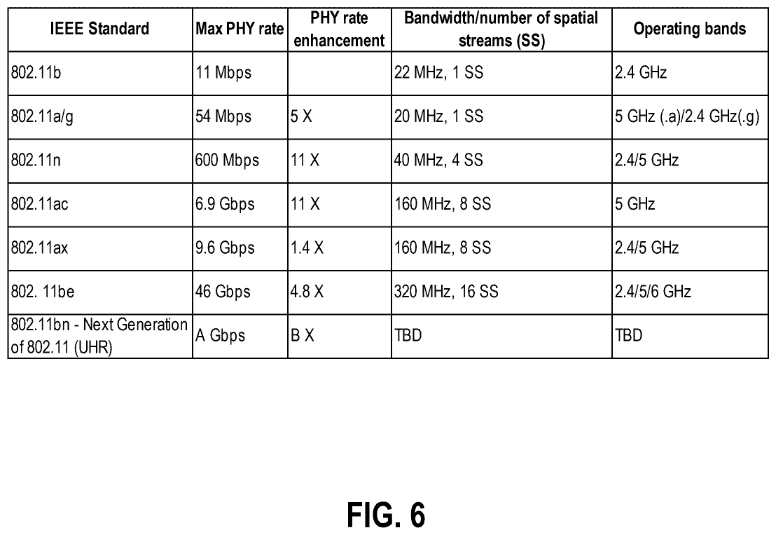

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHZ), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHZ band (5.925-7.125 GHZ) is being considered for unlicensed use. This would allow APs and STAs to become tri-band devices. Larger than 160 MHz data transmissions (e.g., 320 MHZ or 640 MHZ) could be considered to increase the maximum PHY rate. For example, 320 MHZ or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

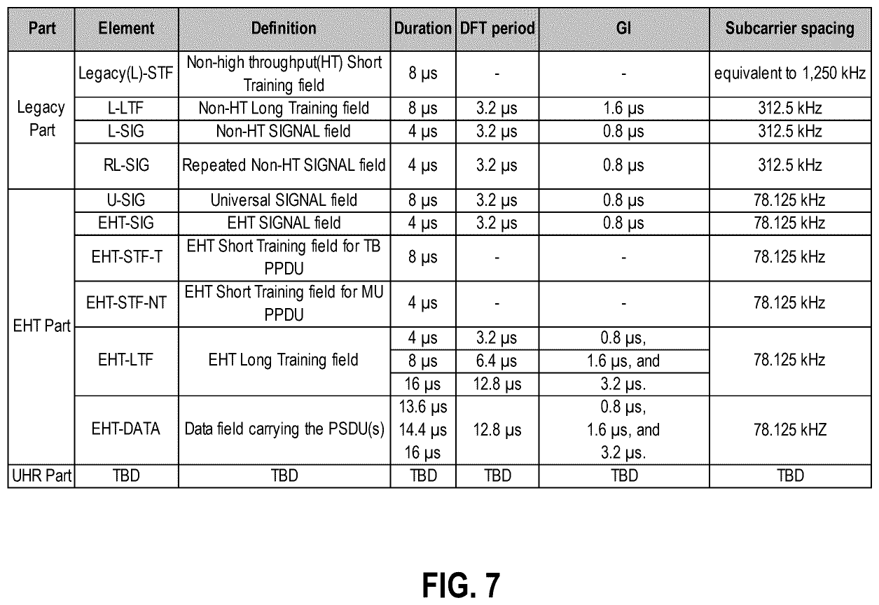

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

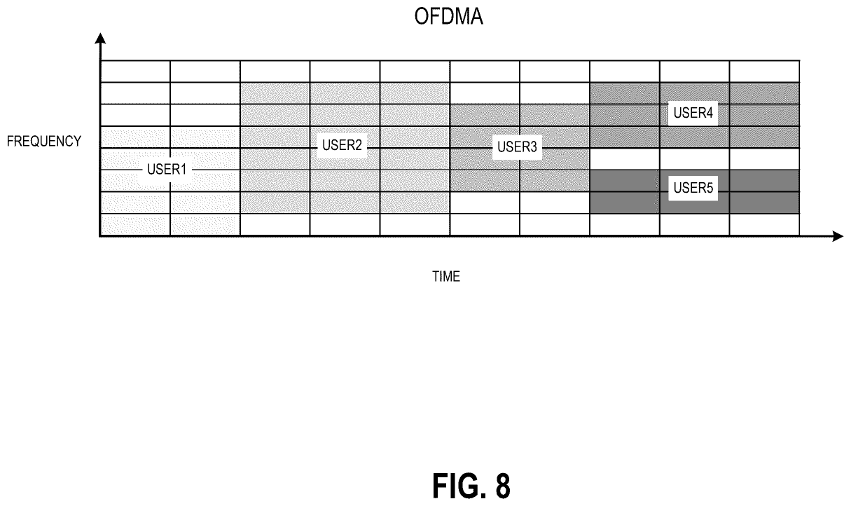

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

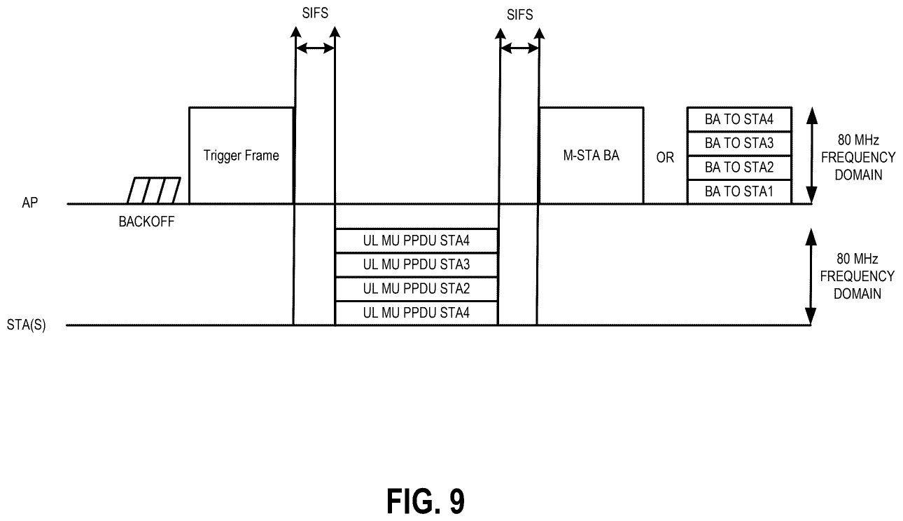

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

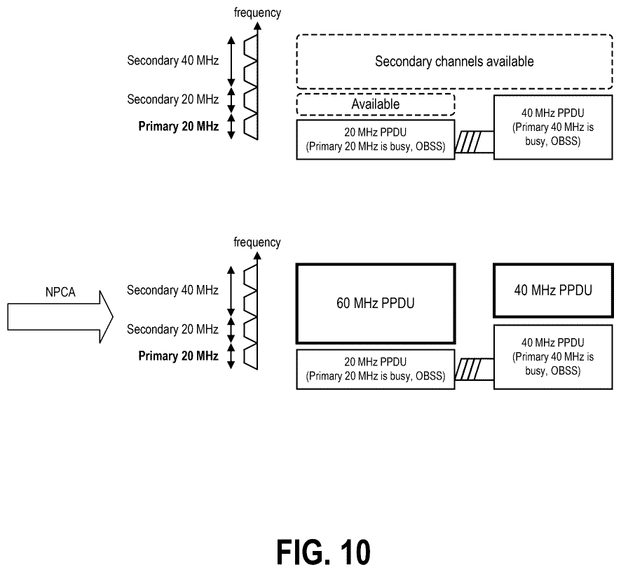

FIG. 10 is a diagram showing the overcall concept of NPCA, according to some embodiments.

The diagram shows the overall concept of NPCA when the operating bandwidth is 80 MHz. It should be appreciated, however, that NPCA is not limited to being used with an 80 MHz operating bandwidth but can be used with other operating bandwidth sizes. The 80 MHZ operating bandwidth may include a primary 20 MHz (P20) channel, a secondary 20 MHZ (P20) channel, and a secondary 40 MHz (S40) channel. As shown in the diagram, when a 20 MHZ PPDU is transmitted in the P20 channel, the S20 channel and the S40 channel may be available. Also, when a 40 MHz PPDU is transmitted in the P40 channel, the S40 channel may be available. Traditional IEEE 802.11 wireless networks have a rule that does not allow transmission in non-primary channels (e.g., secondary channels) when the primary channel (e.g., the P20 channel) is busy even if the non-primary channels are idle. However, with NPCA, even if the primary channel is busy due to OBSS signals, transmission and reception may be allowed in a non-primary channel if certain conditions are met (e.g., clear channel assessment (CCA) indicates that the non-primary channel is idle). For example, as shown in the diagram, a 60 MHz PPDU may be transmitted in the S20 channel and S40 channel while a 20 MHz PPDU is transmitted in the P20 channel. As another example, a 40 MHz PPDU may be transmitted in the S40 channel while another 40 MHz PPDU is transmitted in the P20 channel and the S20 channel. By making use of otherwise unused non-primary channels, NPCA may improve channel utilization and thus improve the overall throughput in the wireless network.

To perform NPCA successfully, the following issues should be taken into consideration.

NPCA operation time: NPCA can be performed during the time period that an OBSS occupies the primary channel for transmission/reception. The NPCA should end when the OBSS transmission/reception in the primary channel ends. If NPCA continues in the non-primary channel even after the OBSS transmission/reception in the primary channel has ended, fairness issues can arise with regard to legacy STAs that are unable to perform NPCA (the legacy STAs will not have a fair chance to access the wireless medium). After the OBSS transmission/reception in the primary channel ends, a situation should be provided that allows fair competition among STAs attempting to occupy the wireless medium. This is because the wireless network should return to its state before NPCA was performed. Thus, it is important for STAs that wish to perform NPCA to be aware of how long it is allowed to perform NPCA for. The time period during which a STA is allowed to perform NPCA may be referred to herein as the NPCA period. Certainly, if after the NPCA period ends, an OBSS occupies the primary channel again, NPCA can be performed again while the OBSS occupies the primary channel.

Determining non-primary channel (e.g., bandwidth) that is available for NPCA operation: NPCA should be performed in a manner that does not interfere with the OBSS signals in the primary channel. For example, considering a STA having an 80 MHz operating bandwidth, if OBSS transmission and reception occur in the P40 channel within the 80 MHZ operating bandwidth, the STA may consider non-primary channels that exclude the P40 channel (that are outside of the P40 channel) as candidate channels that are available for NPCA operation.

Switching timing for NPCA operation: As mentioned above, NPCA can only be performed while the OBSS occupies the primary channel. As such, to maximize the length of time for performing NPCA, it is important to be able to quickly detect when the OBSS will occupy the primary channel and to quickly switch to using the non-primary channel after detecting that the OBSS will occupy the primary channel.

Detection of OBSS signals: Consider a network topology that includes a first BSS (BSS1) and a second BSS (BSS2) with overlapping coverage areas. BSS1 includes AP1 and STA1. BSS2 includes AP2 and STA2. AP2 of BSS2 is located such that it can overhear the transmission and reception of BSS1's STAs (e.g., AP1 and STA1), while STA2 of BSS2 is located such that it cannot overhear the transmission and reception of BSS1's STAs. In such a situation, assume a scenario where AP1 of BSS1 performs transmission and reception with STA1 in a primary channel. AP2 of BSS2 is able to overhear the transmission and reception in BSS1 so it may switch to using a non-primary channel to perform NPCA. However, STA2 of BSS2 is not able to overhear the transmission and reception in BSS1 so it does not switch to using the non-primary channel and does not attempt to perform NPCA. If AP2 of BSS2 cannot recognize this situation (e.g., cannot recognize that STA2 is not able to overhear the transmission and reception in BSS1), it might attempt to perform NPCA with STA2 in the non-primary channel without success (e.g., because STA2 does not switch to using the non-primary channel), which may result in unnecessary transmission and battery consumption. Thus, being able to detect OBSS signals is important for successful NPCA operation.

Depending on the network topology, different wireless devices that wish to participate in NPCA may have inaccurate/different views of the primary channel occupied by the OBSS (and thus different views of the non-primary channel that is available for NPCA), which can result in unsuccessful NPCA operation and cause interference in the OBSS. The present disclosure describes a technique that allows wireless devices to determine a non-primary channel that is available for NPCA in a consistent manner (so that the wireless devices have the same view of the non-primary channel that is available for NPCA). The technique disclosed herein may allow NPCA to be performed without causing interference in the OBSS, resulting in a more efficient use of wireless network resources.

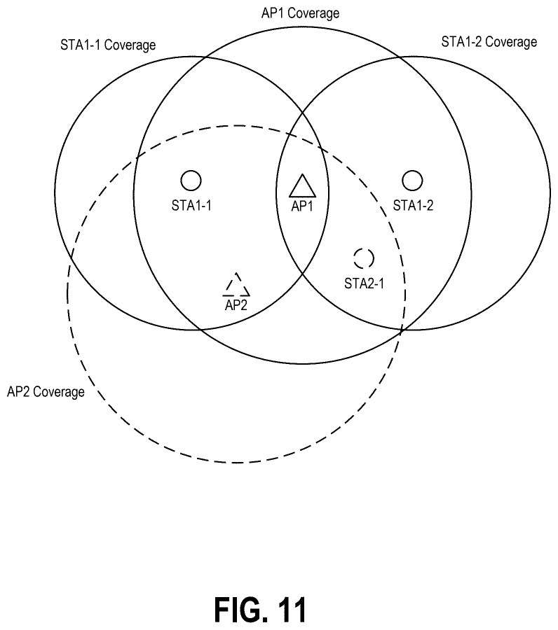

FIG. 11 is a diagram showing a wireless network topology in which NPCA may be performed, according to some embodiments.

As shown in the diagram, the wireless network topology includes a first access point (“AP1”), a first STA (“STA1-1”) associated with AP1, and a second STA (“STA1-2”) associated with AP1. AP1, STA1-1, and STA1-2 may belong to a first BSS (BSS1). Also, the topology includes a second access point (“AP2”) and a STA (“STA2-1”) associated with AP2. AP2 and STA2-1 may belong to a second BSS (BSS2).

AP1 may have an operating bandwidth of 80 MHz while STA1-1 and STA1-2 may have an operating bandwidth of 40 MHz. AP2 and STA2-1 may both have an operating bandwidth of 160 MHz. The primary channel of AP1, STA1-1, STA1-2, AP2, and STA2-1 may be the same. AP2 and STA2-1 may be located within AP1's coverage area. AP2 may be located within STA1-1's coverage area but STA2-1 may be located outside STA1-1's coverage area. STA2-1 may be located within STA1-2's coverage area but AP2 may be located outside of STA1-2's coverage area.

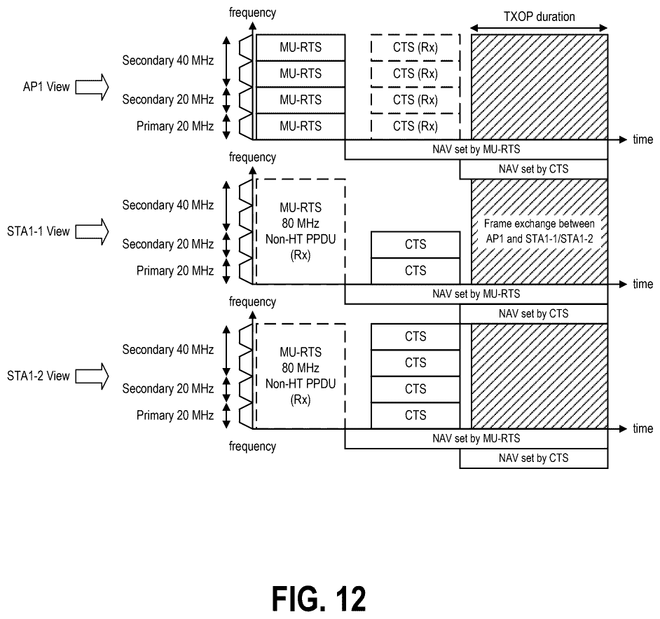

FIG. 12 is a diagram showing an example of a MU-RTS frame and CTS frame exchange in BSS1, according to some embodiments.

As shown in the diagram, AP1 may transmit a MU-RTS frame to STA1-1 and STA1-2 in the 80 MHz bandwidth to initiate communication with STA1-1 and STA1-2. The MU-RTS frame may be transmitted in a duplicated format (MU-RTS frames are duplicated in units of 20 MHz). The MU-RTS frame may include a common information (or “common info”) field that includes an uplink bandwidth (UL BW) field. The UL BW field may be used to indicate the bandwidth of the PPDU carrying the MU-RTS frame (which may simply be referred to as the bandwidth of the MU-RTS frame). In this example, it is assumed that the PPDU bandwidth is 80 MHz and the corresponding value is indicated in the UL BW field. The MU-RTS frame may be used for soliciting CTS frames from STA1-1 and STA1-2. The MU-RTS frame may include an indication of the bandwidth of the CTS frames being solicited. This information may be included in the user information (or “user info”) fields of the MU-RTS frame. In this example, it is assumed that AP1 solicits CTS frames from STA1-1 and STA1-2 in a 40 MHz bandwidth and an 80 MHz bandwidth, respectively.

Responsive to receiving the MU-RTS frame from AP1, STA1-1 may transmit a CTS frame to AP1 in the 40 MHz bandwidth (in the P20 channel and S20 channel). Also, responsive to receiving the MU-RTS frame from AP1, STA1-2 may transmit a CTS frame to AP1 in the 80 MHz bandwidth (in the P20 channel, S20 channel, and S40 channel). STA1-1 and STA1-2 may transmit CTS frames in a duplicated format (CTS frames are duplicated in units of 20 MHZ). According to traditional IEEE 802.11 wireless networking standards, the CTS frame must be transmitted in a channel that includes the primary channel (e.g., P20 channel). The MU-RTS frame and CTS frame exchange may establish a TXOP in BSS1 having a TXOP duration. The MU-RTS frame and the CTS frame may cause a NAV to be set (e.g., to protect the TXOP). Once the TXOP is established, AP1 and STA1-1 and/or STA1-2 may exchange frames during the TXOP.

In this situation, AP1 may not be able to clearly determine whether it has successfully received CTS frames from both STA1-1 and STA1-2 based on the bandwidth of the received CTS frame. For example, if the 80 MHz bandwidth used by STA1-2 has good channel quality, AP1 may successfully receive the CTS frame transmitted by STA1-2. However, if the primary 20 MHz bandwidth used by STA1-1 has poor channel quality, STA1-1 may be unable to transmit its CTS frame. From AP1's perspective, it may assume that STA1-2's CTS frame was successfully received but it may not be able to ascertain whether STA1-1 transmitted its CTS frame. In traditional IEEE 802.11 wireless networking standards, when an AP solicits CTS frames from multiple STAs in overlapping channels, there is no provision that allows the AP to individually verify each CTS frame response. As such, AP1 may only be able to identify the STA that responded with the maximum bandwidth it received.

Thus, in a situation where AP1 solicits CTS frames from STA1-1 and STA1-2 in a 40 MHz bandwidth and 80 MHz bandwidth, respectively, if STA1-1 is not able to transmit its CTS frame in the non-HT duplicated PPDU format (e.g., due to poor channel conditions) and STA1-2 is able to successfully transmit its CTS frame in the non-HT duplicate PPDU format in the 80 MHz bandwidth, it may be unclear to AP1 which STA's CTS frame was received in the overlapping bandwidth.

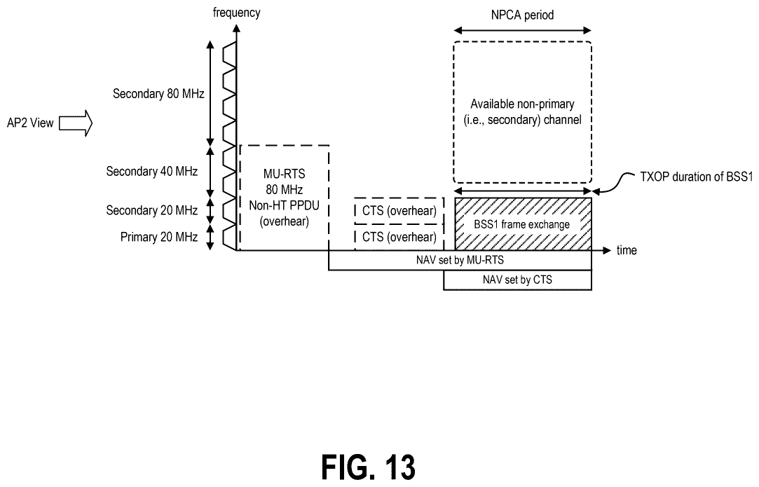

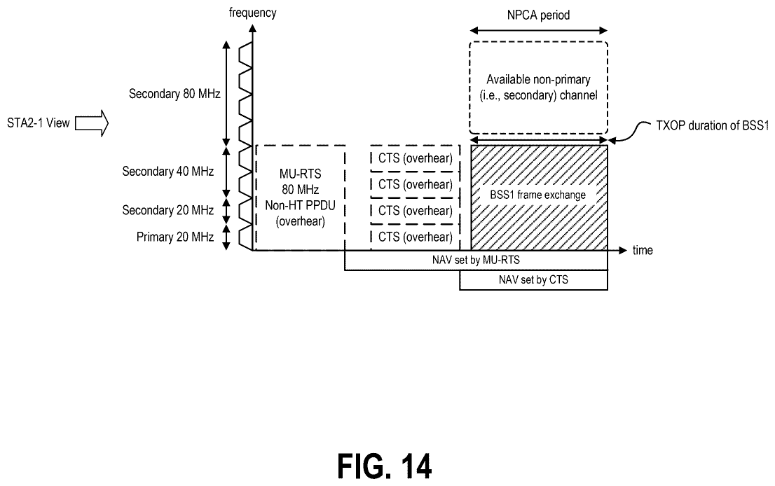

Assuming the wireless network topology shown in FIG. 11, AP2 and STA2-1 may overhear the MU-RTS frame and CTS frame exchange in BSS1 (the frame exchange between AP1 and STA1-1/STA1-2), and perform NPCA in an available non-primary channel during the frame exchange in the primary channel in the OBSS. The frame exchange sequence from the perspectives of AP2 and STA2-1 are shown in FIG. 13 and FIG. 14, respectively. As will be described in further detail herein, due to the wireless network topology, AP2 and STA2-1 may have differing views of the non-primary channel that is available for NPCA.

FIG. 13 is a diagram showing the available non-primary channel from the perspective of AP2, according to some embodiments.

As shown in the diagram, AP2 may overhear the MU-RTS frame and CTS frame exchange in BSS1. This example assumes the wireless network topology shown in FIG. 11 so AP2 is able to overhear the MU-RTS frame transmitted by AP1 (e.g., overhear the entire 80 MHz bandwidth in which the MU-RTS frame was transmitted or at least a portion of it if the MU-RTS frame is transmitted using the non-HT duplicate PPDU format) and the CTS frame transmitted by STA1-1. However, AP2 is not able to overhear STA1-2's CTS frame. Thus, AP2 only overhears the CTS frame in the primary 20 MHz channel and the secondary 20 MHZ channel. Consequently, AP2 may consider the S40 channel and the secondary 80 MHz (S80) channel as being available for NPCA and may attempt to perform NPCA in the S40 channel and S80 channel during the NPCA period (which coincides with the TXOP established in BSS1). The MU-RTS frame and the CTS frame may cause APs/STAs that belong to BSS2 to set a NAV but NPCA-capable APs/STAs that belong to BSS2 (e.g., AP2) may ignore the NAV to perform NPCA.

FIG. 14 is a diagram showing the available non-primary channel from the perspective of STA2-1, according to some embodiments.

As shown in the diagram, STA2-1 may overhear the MU-RTS frame and CTS frame exchange in BSS1. This example assumes the topology shown in FIG. 11 so STA2-1 is able to overhear the MU-RTS frame transmitted by AP1 (e.g., overhear the entire 80 MHz bandwidth in which the MU-RTS frame was transmitted or at least a portion of it if the MU-RTS frame is transmitted using the non-HT duplicate PPDU format) and the CTS frame transmitted by STA1-2. However, STA2-1 is not able to overhear STA1-1's CTS frame. Thus, STA2-1 overhears the CTS frame in the primary 20 MHZ, the secondary 20 MHz channel, and the secondary 40 MHz channel. Consequently, STA2-1 may consider the S80 channel as being available for NPCA. The MU-RTS frame and the CTS frame may cause APs/STAs that belong to BSS2 to set a NAV but NPCA-capable APs/STAs that belong to BSS2 (e.g., STA2-1) may ignore the NAV to perform NPCA.

In the scenario described above, NPCA might fail due to AP2 and STA2-1 having differing views of the non-primary channel that is available for NPCA. For example, AP2 might assume that STA2-1 has the same view of the available non-primary channel as itself and thus transmit a MU-RTS frame to STA2-1 in the S40 channel. However, since STA2-1 only considers the S80 channel as being available for NPCA, STA2-1 may not receive AP2's MU-RTS frame. As a result, NPCA operation may be unsuccessful, and thus the benefits of NPCA (e.g., increased network efficiency) cannot be achieved.

Moreover, if AP2 transmits in the S40 channel, it could interfere with the transmission/reception in BSS1. For example, during the NPCA period, AP2 may transmit an initial control frame (e.g., a MU-RTS frame) to STA2-1 in the S40 channel to initiate communication with STA2-1, which may interfere with BSS1's frame exchange during the TXOP established in BSS1 if the timing of AP2's transmission overlaps with the timing of BSS1's frame exchange.

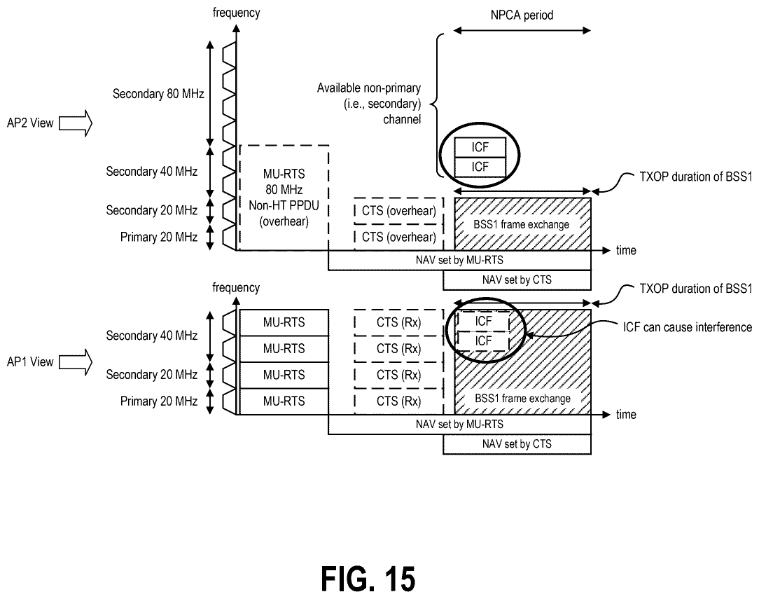

FIG. 15 is a diagram showing how AP2's transmission in a non-primary channel that is perceived by AP2 as being available for NPCA can cause interference in BSS1, according to some embodiments.

As shown in the diagram, AP1 may transmit a MU-RTS frame to STA1-1 and STA1-2 in the 80 MHz bandwidth (primary 80 MHZ (P80) channel) and receive a CTS frame in the 80 MHz bandwidth as a response. This MU-RTS frame and CTS frame exchange may establish a TXOP in BSS1. AP1 may then exchange frames with STA1-1 and/or STA1-2 (shown in the diagram as “BSS1 frame exchange”) during the TXOP established in BSS1. The frame exchange in BSS1 may occupy the 80 MHz bandwidth.

AP2 may overhear the MU-RTS frame transmitted by AP1 in the P80 channel but may only be able to overhear the CTS frame transmitted by STA1-1 in the P20 channel and S20 channel (and not overhear the CTS frame transmitted by STA 1-2 in the P80 channel). Thus, AP2 may consider the S40 channel (or one of the 20 MHz width channels within the S40 channel) as being a non-primary channel that is available for NPCA. As such, after overhearing the CTS frame, AP2 may transmit an initial control frame (“ICF”) in the S40 channel (or one of the 20 MHz width channels within the S40 channel) during the NPCA period but this may interfere with the frame exchange in the P80 channel in BSS1 during the TXOP established in BSS1.

The present disclosure provides a technique for addressing the problem that may arise due to wireless devices that wish to perform NPCA having different views of the non-primary channel that is available for NPCA.

In an embodiment, wireless devices that wish to perform NPCA determine the non-primary channel that is available for NPCA based on bandwidth information included in a field of a control frame (e.g., MU-RTS frame or RTS frame) overheard in the OBSS. In an embodiment, the control frame is a MU-RTS frame and the field from which the bandwidth information is extracted is the UL BW field of the MU-RTS frame. The UL BW field is used for indicating the bandwidth of the MU-RTS frame. Wireless devices may consider a non-primary channel that excludes the bandwidth indicated by the bandwidth information (a non-primary channel that is outside of the bandwidth) or a non-primary channel that excludes the maximum possible bandwidth of the control frame (e.g., if bandwidth information is not available in the control frame, to take a conservative approach) as being available for NPCA and perform NPCA in that non-primary channel.

For example, continuing with the example described earlier herein, the MU-RTS frame transmitted by AP1 to STA1-1 and STA1-2 may include a UL BW field that includes bandwidth information indicating an 80 MHz bandwidth. AP2 and STA2-1, which overhear the MU-RTS frame transmitted by AP1, may consider the non-primary channel that excludes the 80 MHz bandwidth (excludes the P80 channel) as being available for NPCA. For example, if AP2 and STA2-1 have an operating bandwidth of 160 MHZ, they may each regard the S80 channel as being available for NPCA. Thus, AP2 and STA2-1's view of the available non-primary channel may be aligned, enabling successful NPCA operation. The technique disclosed herein is based on the recognition that the maximum channel size occupied by a received CTS frame can be determined by examining the (MU-)RTS frame that triggered the CTS frame (e.g., by examining the UL BW field included in the (MU-)RTS frame).

In an embodiment, wireless devices perform NPCA after overhearing the control frame exchange (e.g., MU-RTS frame and CTS frame exchange) in the OBSS and also after overhearing the PPDU transmitted in the OBSS following the control frame exchange. A wireless device may determine the non-primary channel that is available for NPCA based on bandwidth information included in the PPDU overheard in the OBSS. The wireless device may extract the bandwidth information from a physical layer (PHY) preamble of the PPDU and consider the non-primary channel that excludes the bandwidth indicated by the extracted bandwidth information as being available for NPCA.

The bandwidth information may be extracted from different fields of the PHY preamble depending on the PPDU type (e.g., depending on whether the PPDU is a HE PPDU, EHT PPDU, or UHR PPDU). For example, when overhearing a HE PPDU in an OBSS, a wireless device that wishes to perform NPCA may extract bandwidth information from the bandwidth field included in the HE-SIG-A field of the PHY preamble of the PPDU, and consider a non-primary channel that excludes the bandwidth indicated by the extracted bandwidth information as being available for NPCA. When overhearing an EHT PPDU, a wireless device that wishes to perform NPCA may extract bandwidth information from the bandwidth field included in the U-SIG field of the PHY preamble of the PPDU, and consider a non-primary channel that excludes the bandwidth indicated by the extracted bandwidth information as being an available for NPCA. When overhearing a UHR PPDU, a wireless device that wishes to perform NPCA may extract bandwidth information from the bandwidth field included in the U-SIG field of the PHY preamble of the PPDU, and consider a non-primary channel that excludes the bandwidth indicated by the bandwidth information as being available for NPCA. Alternatively, if the PPDU includes a UHR preamble that precedes the U-SIG field, the wireless device may extract bandwidth information (indicating the bandwidth of the PPDU) from a field included in the UHR preamble, and consider a non-primary channel that excludes the bandwidth indicated by the extracted bandwidth information as being available for NPCA.

The technique disclosed herein allows wireless devices that wish to perform NPCA to have the same view of the non-primary channel that is available for NPCA, which allows for successful NPCA operation without causing interference in an OBSS. This improves the overall throughput and efficiency of the wireless network (e.g., by making use of the available non-primary channel and avoiding interference in the primary channel in the OBSS).

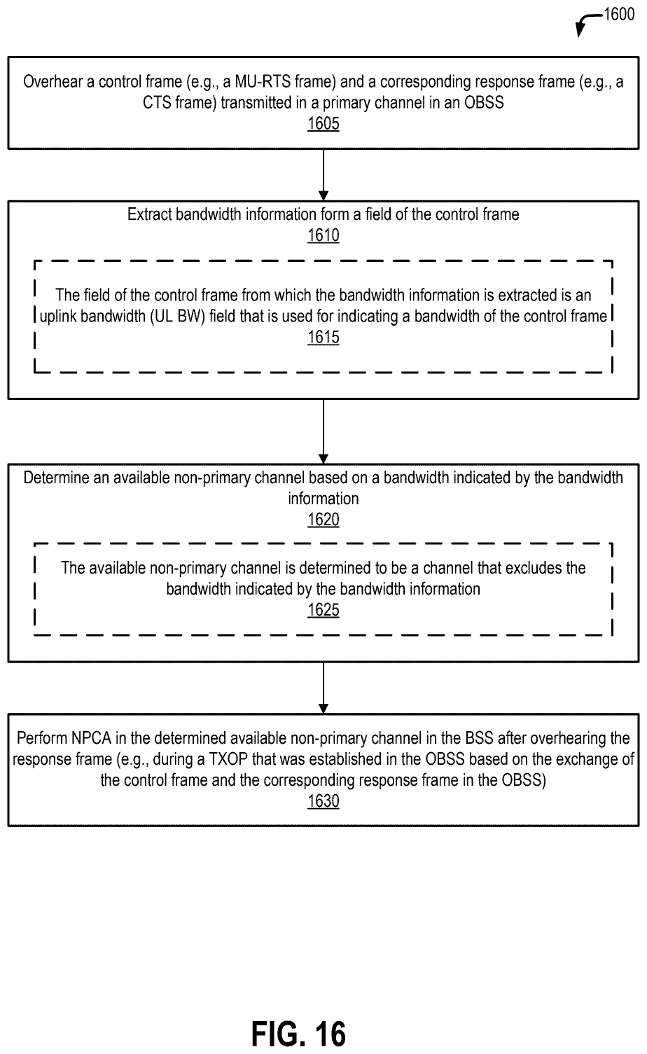

Turning now to FIG. 16, a method 1600 will be described for performing NPCA, in accordance with an example embodiment. The method 1600 may be performed by a wireless device (e.g., wireless device 104) that belongs to a BSS.

Additionally, although shown in a particular order, in some embodiments the operations of the method 1600 (and the other methods shown in the other figures) may be performed in a different order. For example, although the operations of the method 1600 are shown in a sequential order, some of the operations may be performed in partially or entirely overlapping time periods.

At operation 1605, the wireless device overhears a control frame (e.g., a MU-RTS frame) and a corresponding response frame (e.g., a CTS frame) transmitted in a primary channel in an OBSS.

At operation 1610, the wireless device extracts bandwidth information from a field of the control frame. In an embodiment, as shown in block 1615, the control frame is a MU-RTS frame and the field of the control frame from which the bandwidth information is extracted is a UL BW field that is used for indicating a bandwidth of the control frame.

At operation 1620, the wireless device determines an available non-primary channel based on a bandwidth indicated by the bandwidth information. In an embodiment, as shown in block 1625, the available non-primary channel is determined to be a channel that excludes the bandwidth indicated by the bandwidth information (i.e., that is outside of the bandwidth indicated by the bandwidth information). For example, when the wireless device has a 160 MHZ operating bandwidth and the bandwidth indicated by the extracted bandwidth information is 80 MHz, the wireless device may determine that the available non-primary channel is a secondary 80 MHz channel.

At operation 1630, the wireless device performs NPCA in the determined available non-primary channel in the BSS after overhearing the response frame. The wireless device may perform NPCA during a TXOP that was established in the OBSS based on the exchange of the control frame and the corresponding response frame in the OBSS. The wireless device may end the NPCA when the TXOP established in the OBSS ends.

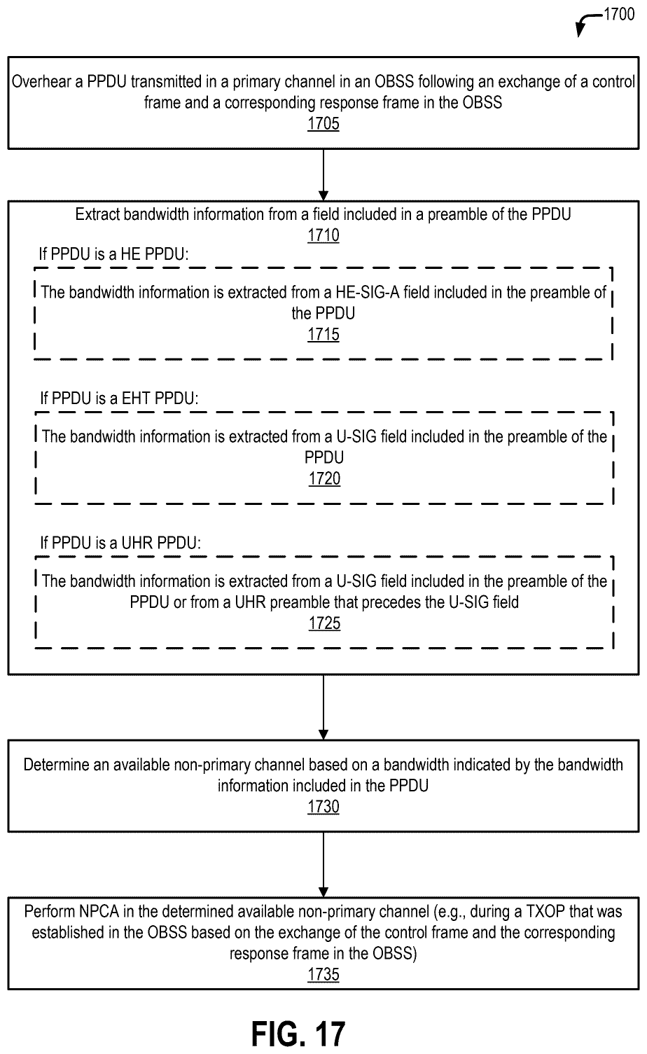

Turning now to FIG. 17, a method 1700 will be described for performing NPCA, in accordance with an example embodiment. The method 1700 may be performed by a wireless device (e.g., wireless device 104) that belongs to a BSS.

At operation 1705, the wireless device overhears a PPDU transmitted in a primary channel in an OBSS following an exchange of a control frame and a corresponding response frame in the OBSS.

At operation 1710, the wireless device extracts bandwidth information from a field included in a preamble of the PPDU. In an embodiment, as shown in block 1715, if the PPDU is a HE PPDU, the bandwidth information is extracted from a HE-SIG-A field included in the preamble of the PPDU. In an embodiment, as shown in block 1720, if the PPDU is a EHT PPDU, the bandwidth information is extracted from a U-SIG field included in the preamble of the PPDU. In an embodiment, as shown in block 1725, if the PPDU is a UHR PPDU, the bandwidth information is extracted from a U-SIG field included in the preamble of the PPDU or from a UHR preamble that precedes the U-SIG field.

At operation 1730, the wireless device determines an available non-primary channel based on a bandwidth indicated by the bandwidth information included in the PPDU.

At operation 1735, the wireless device performs NPCA in the determined available non-primary channel (e.g., during a TXOP that was established in the OBSS based on the exchange of the control frame and the corresponding response frame in the OBSS).

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a wireless device belonging to a basic service set (BSS) to perform non-primary channel access (NPCA), the method comprising:
overhearing a control frame and a corresponding response frame transmitted in a primary channel in an overlapping basic service set (OBSS);
extracting bandwidth information from a field of the control frame;
determining an available non-primary channel based on a bandwidth indicated by the bandwidth information; and
performing NPCA in the determined available non-primary channel in the BSS after overhearing the response frame.

2. The method of claim 1, wherein the control frame is a multi-user request-to-send (MU-RTS) frame and the response frame is a clear-to-send (CTS) frame.

3. The method of claim 2, wherein the field of the control frame from which the bandwidth information is extracted is an uplink bandwidth field that is used for indicating a bandwidth of the control frame.

4. The method of claim 1, wherein the available non-primary channel is determined to be a channel that excludes the bandwidth indicated by the bandwidth information.

5. The method of claim 4, wherein when the wireless device has a 160 Megahertz (MHz) operating bandwidth and the bandwidth indicated by the bandwidth information is 80 MHZ, the available non-primary channel is determined to be a secondary 80 MHz channel.

6. The method of claim 1, wherein the NPCA is performed during a transmission opportunity (TXOP) in the OBSS, wherein the TXOP was established in the OBSS based on an exchange of the control frame and the response frame in the OBSS.

7. The method of claim 6, further comprising:
ending the NPCA when the TXOP ends.

8. The method of claim 1, wherein the wireless device operates as an access point (AP) or a non-AP station (STA) in the BSS.

9. A wireless device configured to perform non-primary channel access (NPCA) in a basic service set (BSS), the wireless device comprising:
a radio frequency transceiver;
a memory device storing a set of instructions; and
a processor coupled to the memory device, wherein the set of instructions, when executed by the processor, causes the wireless device to:
overhear a control frame and a corresponding response frame transmitted in a primary channel in an overlapping basic service set (OBSS);
extract bandwidth information from a field of the control frame;
determine an available non-primary channel based on a bandwidth indicated by the bandwidth information; and
perform NPCA in the determined available non-primary channel in the BSS after overhearing the response frame.

10. The wireless device of claim 9, wherein the control frame is a multi-user request-to-send (MU-RTS) frame and the response frame is a clear-to-send (CTS) frame.

11. The wireless device of claim 10, wherein the field of the control frame from which the bandwidth information is extracted is an uplink bandwidth field that is used for indicating a bandwidth of the control frame.

12. The wireless device of claim 9, wherein the available non-primary channel is determined to be a channel that excludes the bandwidth indicated by the bandwidth information.

13. The wireless device of claim 12, wherein when the wireless device has a 160 Megahertz (MHz) operating bandwidth and the bandwidth indicated by the bandwidth information is 80 MHz, the available non-primary channel is determined to be a secondary 80 MHz channel.

14. The wireless device of claim 9, wherein the NPCA is performed during a transmission opportunity (TXOP) in the OBSS, wherein the TXOP was established in the OBSS based on an exchange of the control frame and the response frame in the OBSS.

15. The wireless device of claim 14, wherein the set of instructions, when executed by the processor, further causes the wireless device to:
ending the NPCA when the TXOP ends.

16. The wireless device of claim 9, wherein the wireless device is configured to operate as an access point (AP) or a non-AP station (STA) in the BSS.
